(19) United States
(12) Patent Application Publication
(10) Pub. No.: US 2004/0169411 A1
(43) Pub. Date: Sep. 2, 2004

(54) Add-on safety harness for vehicles

(76) Inventor: Constance S. Murray, Palm City, FL (US)

Correspondence Address: Richard C. Litman, LITMAN LAW OFFICES, LTD., P.O. Box 15035, Arlington, VA, 22215, US

(21) Appl. No.: 10/799,632

(22) Filed: Mar. 15, 2004

Related U.S. Application Data
(63) Continuation-in-part of application No. 10/106,208, filed on Mar. 27, 2002.
(60) Provisional application No. 60/281,376, filed on Apr. 5, 2001.

(51) Int. Cl. B60R 21/00

(52) U.S. Cl. 297/486; 280/801.1

(57) ABSTRACT

An add-on safety harness for a vehicle seat having a lap belt. An elongated anchor strap for attaching vertically around a seat back has an adjustable buckle. A first pair of shoulder straps extends at an acute angle from each side of the anchor strap, and ending in a loop. A second pair of leg straps with looped ends extends similarly from each side of the anchor strap. Each shoulder strap has a roll-type adjuster device at a median position. A piece of soft material, such as synthetic cloth or lambs' wool is attached to each adjuster device for wrapping around the adjuster device, being fastened by hook and loop fastening material. In simplified arrangement, the harness has an inverted Y-shape formed from only an anchor strap and a pair of harness shoulder straps. The lap belt of the vehicle seat is threaded through the loops of the shoulder and leg straps. The leg straps can be positioned inside the shoulder strap for smaller passengers, such as children and outside the shoulder harness strap for larger passengers.

The present application is a Continuation-in-Part of the copending U.S. nonprovisional application Ser. No. 10/106,208, filed Mar. 27, 2002, which claims the benefit of U.S. Provisional Patent Application Serial No. 60/281,376, filed Apr. 5, 2001.

### BACKGROUND OF THE INVENTION

1. Field of the Invention

The present invention relates generally to vehicle safety belts. More specifically, the invention is a portable restraining belt for use by vehicular passengers, particularly children, along with an available lap safety belt.

2. Description of the Related Art

The related art of interest describes various harnesses for vehicles, but none discloses the present invention. There is a need for a dependable, portable, removable student-harness for a school bus. The related art will be discussed in the order of perceived relevance to the present invention. U.S. Pat. No. 3,834,758 issued on Sep. 10, 1974, to Frank A. Soule, describes a safety belt harness for use on motor vehicles to restrain vehicle occupants in the event of a sudden stop or accident, including a combination of a pair of spaced parallel back straps, a lap strap, and a buckle.

U.S. Pat. No. 4,709,966 issued on Dec. 1, 1987, to James G. Parkinson, describes a protective device for restraining a child in a vehicular seat including a plurality of straps intertwined, and surrounding the torso of the child being restrained. The protective device allows a child to stand on a vehicle seat, and upon a sudden stop, or accident, the child may lose his footing, and consequently exit the protective device from the unrestrained bottom.

U.S. Pat. No. 5,733,014 issued on Mar. 31, 1998, to Connie Murray, herein incorporated by reference, describes a restraint harness attachable to a school bus bench seat having at least one loop encircling the back of the bench seat and joined near the seat by a belt with separate male tongues for combining with the buckles from the back encircling loops. In effect a combination lap belt and two shoulder belts.

U.K. Patent Document No.2,275,597, published on Sep. 7, 1994 to David Lennox-Lamb describes an adaptor arrangement for lap-belt having an adjustable anchor strap, and a shoulder strap. The shoulder strap is slidably coupled to an end of the anchor strap, which during use may entangle the wearers hair causing pain and discomfort.

U.S. Pat. No. 3,954,280 issued on May 4, 1976, to Verne L. Roberts et al. describes a child auto restraint harness having a rigid strap plate having an anchor strap secured thereto with the opposite end of the anchor strap secured to means for transferring impact energy to the frame of the vehicle. Two shoulder straps are also affixed to the strap plate. The anchor strap wraps around and attaches behind the car seat.

U.S. Pat. No. 4,205,670 issued on Jun. 3, 1980, to James R. Owens describes a child's restraining harness for use on school buses, vans, and other vehicles. The harness includes a pair of straps with a means for interconnecting the ends of the straps around the seat back. A number of aligned loops are formed on each strap. A waist belt and a chest belt each pass through a pair of aligned loops on the straps.

U.S. Pat. No. 5,131,683 issued on Jul. 21, 1992, to Ellis D. Johnson describes a torso restraining assembly for an automobile seat having a Y-section in front with a pair of shoulder straps that extend over the back of the car seat and anchored separately on the floor. The front section has a loop on the leg of the Y-section for passing a seat belt through.

U.S. Pat. No. 5,624,135 issued on Apr. 29, 1997, to Barbara J. Symonds describes a portable seat belt attachable to a school bus bench seat comprising two loops encircling the back of the bench seat and joined near the seat by a belt with separate male tongues for combining with the buckles from the back encircling loops. In effect a combination lap belt and two shoulder belts.

U.S. Pat. No. 4,289,352 issued on Sep. 15, 1981, to Roger A. Ashworth describes a shoulder height adjuster for seat belt systems having shoulder belts comprising a 3-point safety system including a retractor on the floor behind the seat on the passenger's right side which feeds a belt through a guide on a wall and through a main connector, a seat belt connector, around the seat back, and back to the main connector.

U.S. Pat. No. 4,488,691 issued on Dec. 18, 1984, to Daniel L. Lorch describes a harness for restraining the torso of a crewman in a seat aboard an aircraft. The harness has manifold belts which traverse both shoulders and both thighs.

U.S. Pat. No. 4,632,425 issued on Dec. 30, 1986, to Mary A. Barratt describes a passenger restraint system comprising a seat back envelope of heavy duty fabric overlying a seat back and extend below the seat back for anchoring. Additional webbing on the envelope is equipped with various closures. A garment is provided which includes fittings attachable to the envelope. A restraint vest is used in combination with the seat back envelope.

U.S. Pat. No. 5,074,588 issued on Dec. 24, 1991, to Fred Huspen describes a child safety restraint device for a vehicle seat comprising a rectangular back (stress) plate which is fastened to the seat back by the lap belt as well as a yoked belt with buckles passing under the child and to the stress plate.

U.S. Pat. No. 5,080,441 issued on Jan. 14, 1992, to Jennifer L. Stevenson et al. describes a safety seat for a child for airplane use comprising a lap bolster having a retractor system consisting of two tenision straps connected to a male buckle adapter for pulling over the child's head and buckling between the legs.

U.S. Pat. No. 5,135,257 issued on Aug. 4, 1992, to Thomas T. Short describes an adjustable breakaway seat belt shoulder harness comfort strap device for attaching a strap with hook and loop fastening to the shoulder belt and a loop around the seat belt.

U.S. Pat. No. 5,429,418 issued on Jul. 4, 1995, to Carol A. Lipper et al. describes a child safety restraint system comprising a vehicular child restraint harness comprising a vest component including a head opening, a belt which buckles around the lower rib cage and a lower loop for passing the seat belt through.

U.S. Pat. No. 5,536,066 issued on Jul. 16, 1996, to Mark A. Sedlack describes a harness for fixing a-child restraint chair onto a school bus seat comprising a U-shaped harness with a crossing strap.

U.S. Pat. No. 6,123,388 issued on Sep. 26, 2000, to Charles G. Vits et al. describes a restraint system for a school bus bench seat built into the frame of the bench seat.

U.S. Design Pat. No. 328,803 issued on Aug. 18, 1992, to Robert E. Franklin describes a vehicular child restraint harness comprising a waist strap with a buckle in front and a yoked strap attached to the rear of the waist strap and buckled in front to two short extensions on the waist strap. An extended strap at the rear of the waist strap is buckled apparently to the conventional female lap belt buckle.

U.S. Pat. No. 3,888,509 issued on Jun. 10, 1975, to Ronald A. Willey describes a bifurcated shoulder and lap continuous harness comprising a belt that is anchored on one side on the floor, traverses a floor guide and an overhead anchor to travel through another guide anchored on the opposite side on the floor, and traverses over the lap to be anchored on the one side on the floor.

None of the above inventions and patents, taken either singly or in combination, is seen to describe the instant invention as claimed. Thus a add-on safety harness for school bus solving the aforementioned problems is desired.

### SUMMARY OF THE INVENTION

The public is aware of not infrequent school bus accidents involving injury to the children being transported. This invention is an adjunct to existing seat belts on school buses to better protect the child from injury due to a sudden stop. An anchor strap element of the harness device is attached vertically around the seat back and secured by a buckle. The anchor strap has two outwardly extending shoulder straps which have intermediate automatic roll-type length adjusters having a protective sheet of lamb's wool attached by hook and loop fastening. The anchor strap also has two outwardly extending shorter straps with looped ends for threading the existing seat belt through them in order to maintain the position of the harness by not rotating on the seatback. The two shoulder straps have at the unattached ends a loop which enables the threading of the seat belt through the loop. The shorter extending straps are inside the other pair of shoulder straps for a small child, but positioned on the outside of the other pair for larger children. The two shoulder straps are already installed on the buckle side, and therefore would not readily slip off the seat belt. Thus, an add-on body harness is readily added to the bus seat for an improved condition of protection for the child.

Accordingly, the present invention provides a safety harness for children riding a vehicle, especially a school bus, that has been retrofitted with the harness. In addition, the present invention provides a retrofitted safety harness for use with existing lap belts with an anchor strap positioned vertically on the seat back. The invention also provides a safety harness having two pairs of straps extending from the vertical strap, allowing for ease of use by a child in a vehicle. The invention further provides a safety harness which would better protect a child riding a school bus in the event of a vehicular accident.

The invention further provides a kit for adapting older vehicles for use of the add-on safety harness for vehicles. The kit will allow motor vehicles having rear passenger seats that only provide lap belts, the ability to be retro-fitted. In this manner, older vehicles will be equipped to handle most vehicular crash situations, and provide maximum prevention of injury. The kit may be used on any vehicle seat, seat back, or accessible vehicular body structure. In the instance of a later model vehicle having a standard pre-installed anchor point, only the add-on safety harness is used. On other types of vehicles, such as buses, trucks, trailers, campers, etc., the kit provides the versatility to adapt these vehicles so as to provide maximum protection from injury.

### BRIEF DESCRIPTION OF THE DRAWINGS

FIG. 1 is a front elevational view of an add-on safety harness for vehicles according to the present invention, illustrating a child (in shadow) sitting in a vehicle seat.

FIG. 2 is a top plan view of an add-on safety harness vehicles according to the present invention.

FIG. 3 is an environmental front perspective view of an add-on safety harness for vehicles according to the present invention.

FIG. 4 is an environmental rear perspective view of the add-on safety harness for vehicles according to the present invention.

FIG. 5 is an environmental rear perspective view of the add-on safety harness for vehicles according to the present invention.

FIG. 6 is an environmental rear perspective view of the add-on safety harness for vehicles according to the present invention.

FIG. 7 is an environmental perspective view of the add-on safety harness kit for vehicles according to the present invention.

FIG. 8 is an environmental perspective view of the add-on safety harness kit for vehicles according to the present invention.

FIG. 9 is an environmental perspective view of an optional retaining strap for the add-on safety harness kit for vehicles according to the present invention.

Similar reference characters denote corresponding features consistently throughout the attached drawings.

### DETAILED DESCRIPTION OF THE PREFERRED EMBODIMENTS

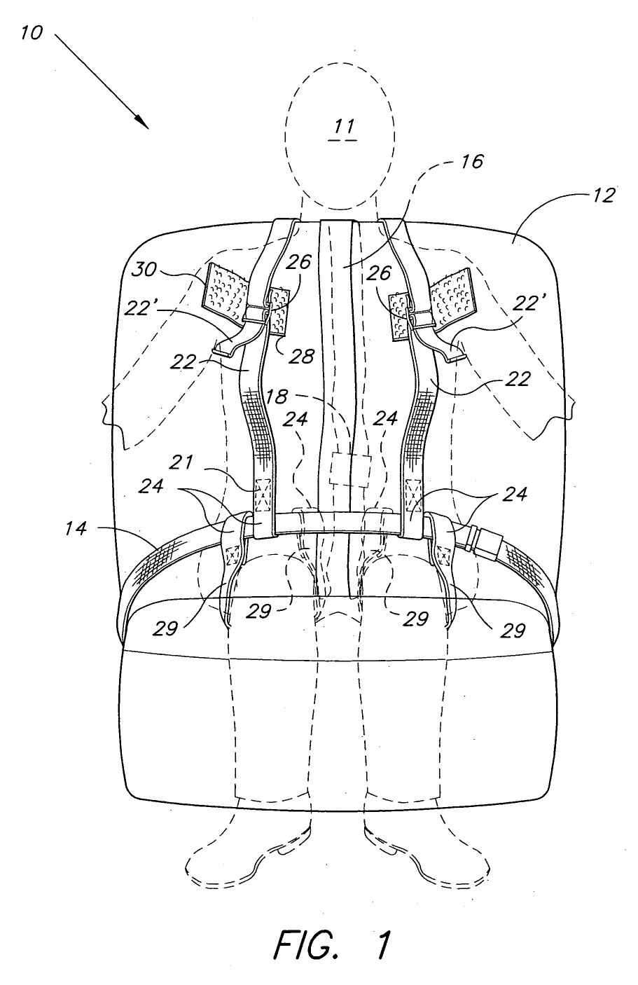

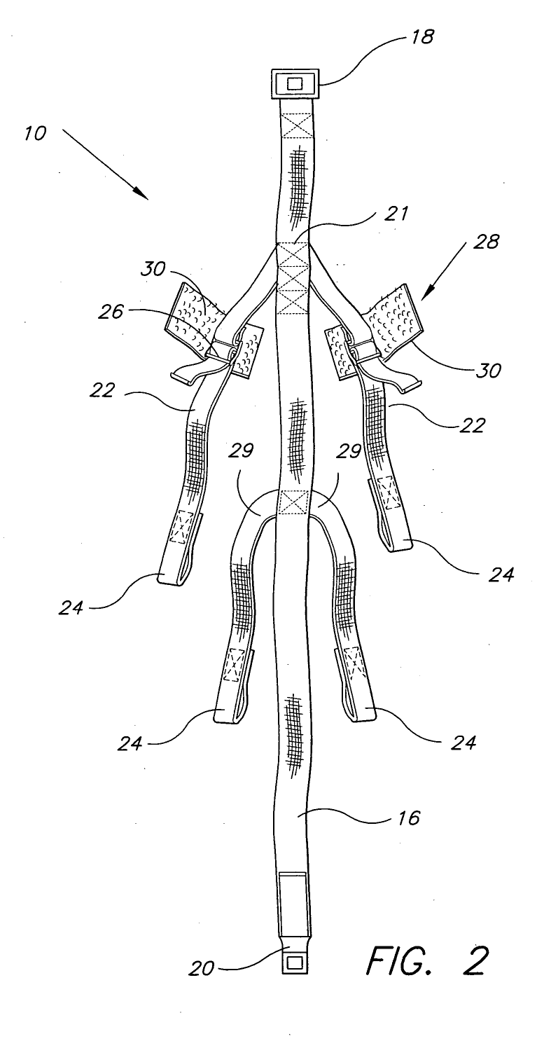

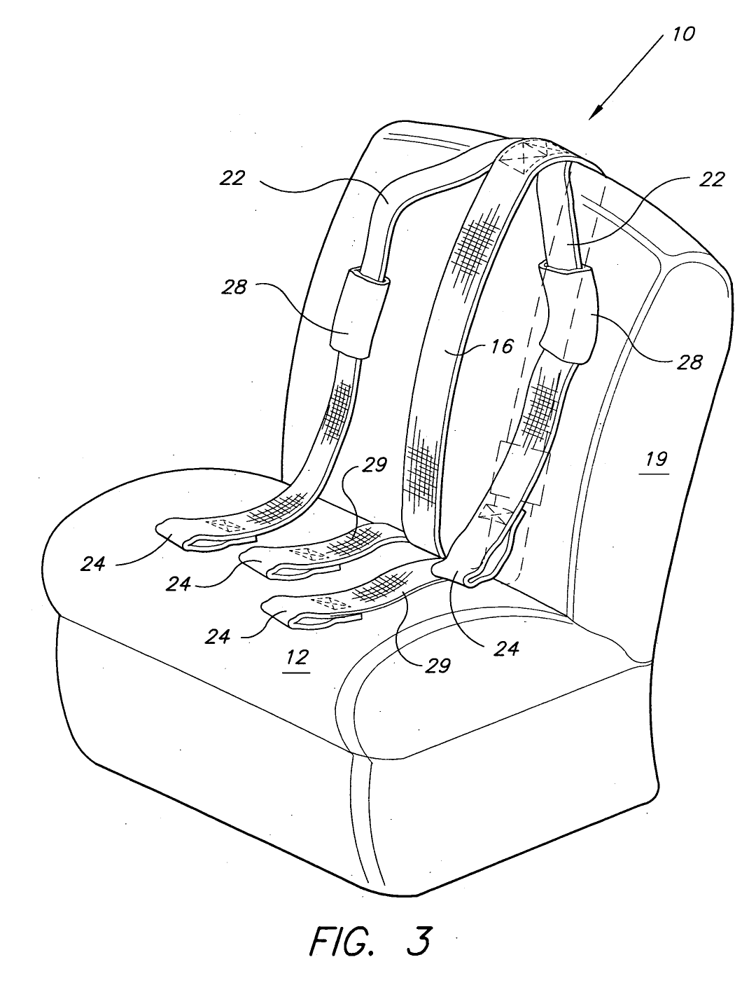

The present invention is illustrated in FIG. 1 as an add-on safety harness 10 on a child passenger 11 (shown in shadow) sitting in a school bus seat 12 having a lap belt 14. The harness 10, as shown in FIG. 2, comprises an elongated two inch wide main seat anchor strap 16 having a female snap-on buckle 18 on one end and a male buckle tongue 20 the opposite end so that the anchor strap 16 can be secured vertically around the seat back 19 as depicted in FIGS. 1, 3 and 4. The buckle 18 and tongue 20 are designed and configured so as to allow length of the strap 16 to be adjusted. It is noted that either the buckle 18 or the tongue 20 includes the means to adjust the length of the strap 16. In addition, the relative position of the buckle 18 and tongue 20 with respect to the strap is inconsequential, as long as upon engaging the tongue 20 into the buckle 18, a closed loop is formed with the strap 16 about a seat back 19.

Stitching 21 on the harness 10 is depicted as crosses. Each one of a pair of two inch wide shoulder harness straps 22 have their proximate ends extending from each side of the anchor strap 16 at an acute angle toward the tongue 20. Each shoulder harness strap 22 has its distal end ending in a two inch wide loop 24. A pair of one inch wide leg harness straps 29, shorter in length than the shoulder harness straps 22, are positioned further down with loops 24 at their ends. The leg harness straps 29 can be positioned in two different positions depending on the size of the child. In FIG. 1, the outside position depicted is for older children, while the dashed inside position is for smaller children. The leg harness straps 29 also prevent the anchor strap 16 from rotating on the seat back 19.

An adjuster device 26 having an adjustable resistance that is adequate to prevent looseness, and is positioned in a median location on each shoulder harness strap 22. A rectangular piece of soft material, such as synthetic cloth or lamb's wool 28 having hook and loop fastening 30 material 30 attached thereto, as shown in FIGS. 1 and 2, is attached to each adjuster device 26 for surrounding each adjuster device in order to soften the pressure of the device 26 against the child's 11 chest.

A passenger, such as a child, can thread one end of the conventional lap belt 14 through the loops 24 of the shoulder harness straps 22 and the loops 24 of the leg harness straps 29, if not already set up, to secure the child passenger, as the pair of adjuster devices 26 adjust the length to press the harness 10 against the chest of the child passenger.

The harness straps 16, 22 and 29 can be made from conventional automotive webbing which is strong and flexible. The add-on safety harness 10 has the advantages of utilization with existing lap type seat belts 14, protection of children on school buses, easy installation, portability for moving from bus to bus or within a bus, requires no special tools to install and maintain, and can adjust to children from age 3 to the teens.

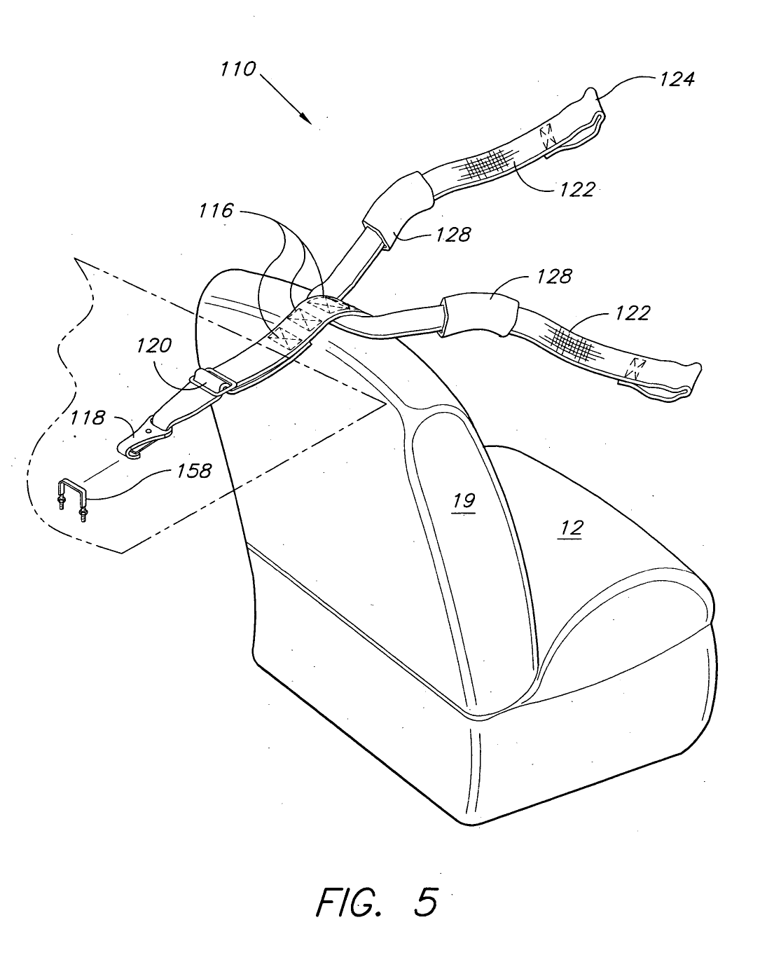

Referring to FIG. 5, a simplified version of the add-on safety harness 110 according to the invention, for vehicles having at least a lap belt and an anchor point is illustrated. The harness has a seat anchor strap 116, the seat anchor strap 116 has a first end 116′, and a second end 116″. A clip-on fastener 118 is connected to the first end 116′. The clip-on fastener 118 is releasibly attached to an anchor point of the vehicle 158. A pair of shoulder harness straps 122,122 are fixedly attached to the second end 116″ of the anchor strap 116. The pair of shoulder harness straps 122,122 extend from the second end 116″, and on opposite sides thereof. Each of the shoulder harness straps 122,122 has a predetermined length. The proximate end of each shoulder strap 122, 122 is the end fixedly attached to the anchor strap 116. Each distal end is formed into a loop 124,124.

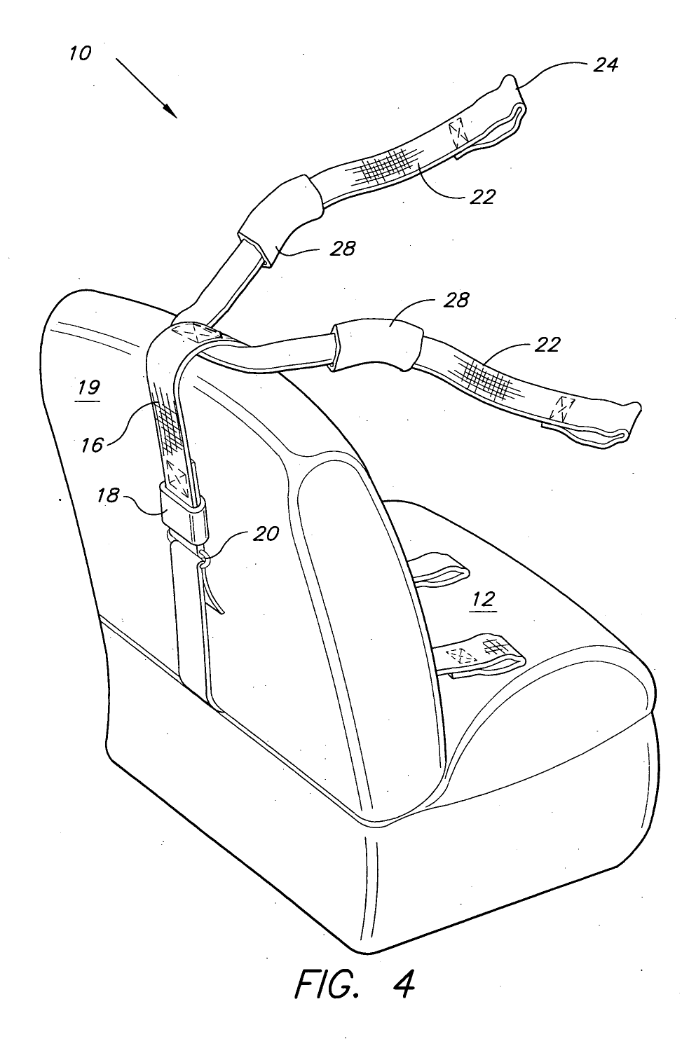

An adjustment device 126 (similar as element 39 or 54 illustrated of FIG. 4 of U.S. Pat. No. 5,733,014) disposed on each harness strap 122,122. The adjustment devices 126 are designed and configured to adjust the length of each the harness strap 122,122 so that the safety harness 110 fits comfortably, yet snugly enough to prevent the passenger 11 from being launched from the seat 112 in a collision situation. The lap belt 14 of the vehicle is threaded through the loop ends 124 of the harness straps 122,122.

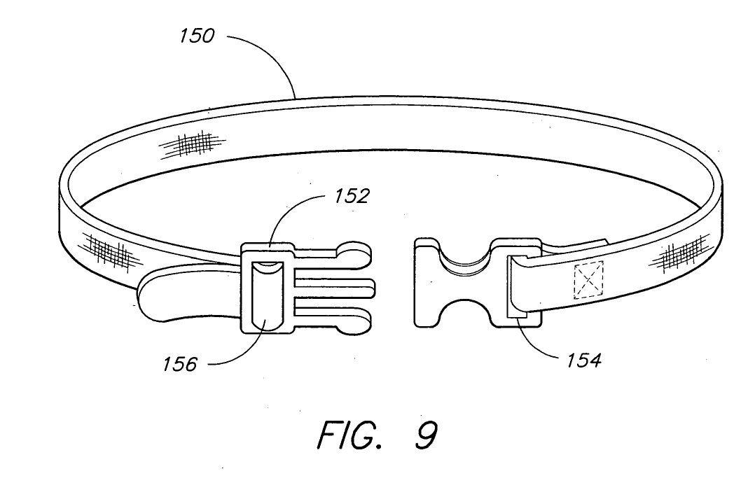

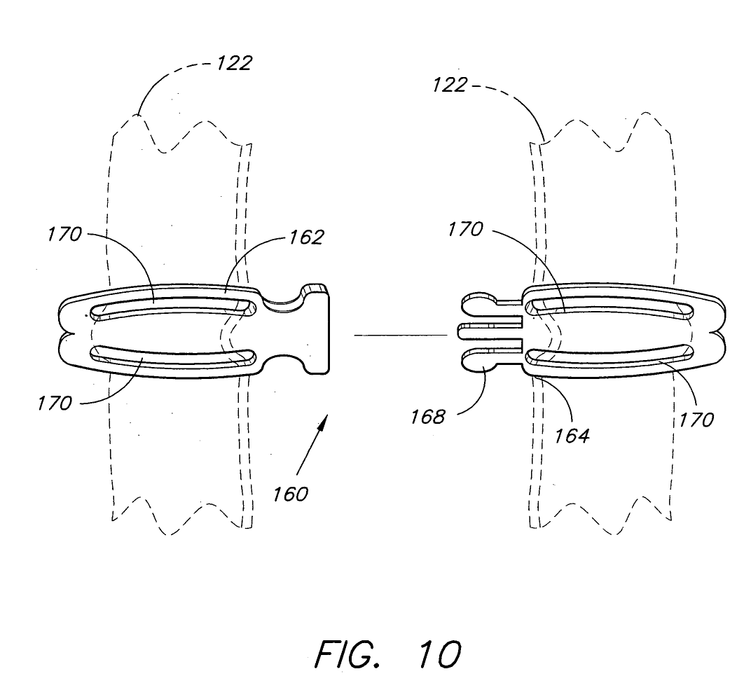

In addition, the safety harness 10 includes an additional optional strap member 150, see FIG. 9. The additional optional strap member 150 has a first end including a first mating fastener part 152 coupled thereto, an a second end including a second mating fastener part 154 coupled thereto. In addition, at least one adjuster 156 for adjusting the length of the additional optional strap 150. The additional optional strap 150 is used to additionally secure the harness shoulder straps 122,122 to maintain the position thereof about the chest of the passenger 11 of a vehicle.

Additionally, FIG. 10 shows a rigid type clip member 160 for maintaining proper positioning of the shoulder straps 122,122 about the chest of the passenger is well within the purview of the appended claims. Referring to FIG. 10, rigid clip 160* having a pair of members 162, 164 that matingly engage via buckle portion 166 on member 162, and a tongue portion 168 on member 164. Each member 162, 164 has at least two slots 170 therein. Slots 170 allow passage of the shoulder straps 22, 122 therethrough, so that when the buckle portion 166 and the tongue portion 168 are matingly engaged, the shoulder straps are maintained in proper orientation-about the chest of the passenger. The additional optional strap 150, or rigid clip 160, may or may not be used however, smaller passengers, such as children, small adults, special needs persons, etc., are more properly restrained during a collision situation if the additional optional strap 150, or rigid clip 160, is used.

The add-on safety harness kit 110 also includes an optional strip of soft material 128 attached to each the harness strap 122,122. The soft material 128 has a fastener (e.g., hook and loop, or snap type) 30 (note FIG. 2) for securing the soft material 128 in proximity to each adjustment device 126. The soft material 128 surrounds each of the adjuster devices 126,126 so as to provide a cushioned surface thereon.

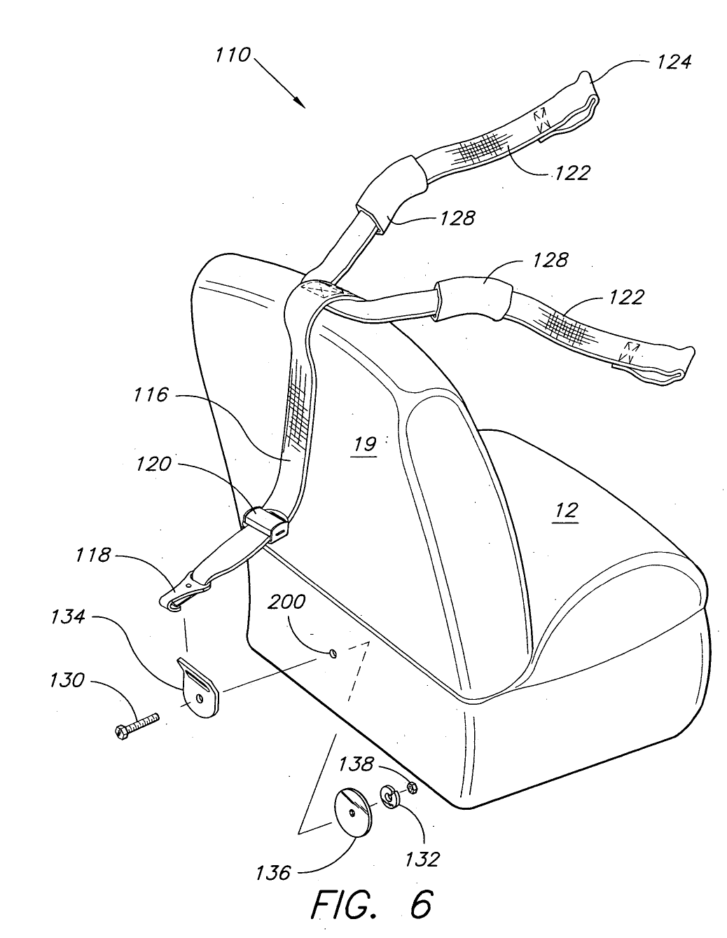

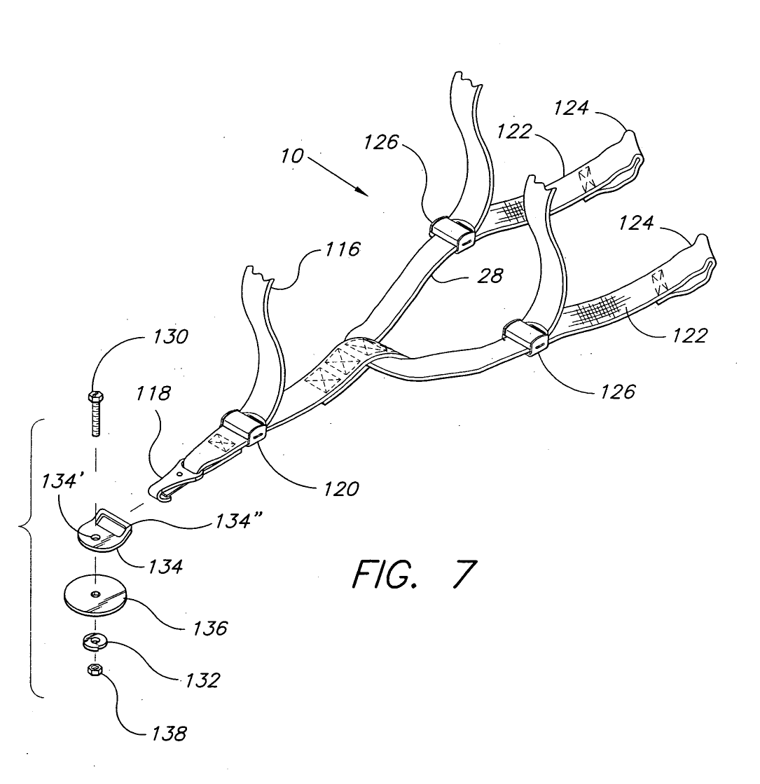

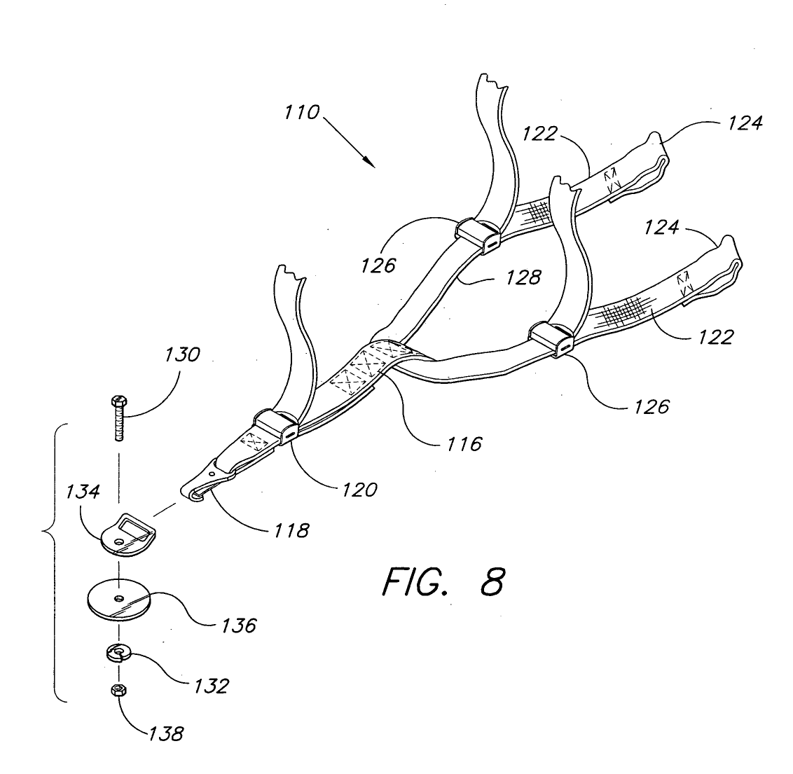

Referring to FIGS. 6-8, the add-on safety harness 10 is part of a kit 110 for retro-fitting vehicles that only have seats 112 with at least a lap belt 14. The kit 110 includes the add-on safety harness 10 of FIG. 5, along with the hardware to retro-fit, or adapt a vehicle. The retro-fitting of the vehicle would require at least one through hole 200 to be available, or bored through the mounting point, in order to accommodate the mounting of the kit 110. The hardware for adapting the vehicle includes a bolt 130, at least one split-ring lock washer 132, an angled plate 134 having a bolt hole 134′ and an eyelet 134″, a mounting washer 136, and a nut 138. Primarily, the angled plate 134 is mounted to the vehicle using the bolt 130 through the bolt hole 134′, the first washer 132, the second washer 136, and the nut 138. The available, or bored, hole 200 in the vehicle allows the arrangement of the bolt hole 134′ of the angled plate 134, the two washers 132,136, and the nut 138 to be concentrically aligned about the hole 200. After the alignment of such, the bolt 130 is concentrically passed through the bolt hole 134′ of the angled plate 134, the available, or bored hole 200, and the two washers 132,136, and the threads of which are engaged with the threads of the nut 138 , so as to establish an anchor point 158 upon which the clip-on fastener 118 is secured to anchor the harness 10 thereon. Thus, the clip-on fastener 118 is releasibly attached to the eyelet 134″ of the angled plate 1 34; one end of a lap belt 14 of the vehicle is threaded through the loops 124,124 of the harness straps 122,122, whereby a passenger 11 is secured into the vehicle seat 112, and the adjustment devices 126,126 are used to adjust the length of the harness straps 122,122.

The hardware is mounted to a point on the vehicle seat 112 that forms a sure and solid attachment. For example, a frame component of the vehicle seat 112 is used to mount the angled plate 134. Likewise, the hardware is mounted to a point on the vehicle that forms a sure and solid attachment. For example, a frame component of the vehicle may be vehicle floor, beneath the vehicle seat. On the other hand, the frame component of the vehicle may be the portion of the vehicle body behind the vehicle seat 112.

The further enhance the versatility of the add-on safety harness kit 110 of the invention, the clip-on fastener 118 is fixedly attached to the first end of the anchor strap 116, see FIG. 7. Also, the clip-on fastener 118 is slidably attached to the first end of the anchor strap. In this manner, the length of the anchor strap is adjustable, thereby allowing the add-on safety harness kit 110 to be used on virtually any vehicle, so long as a seat lap belt 14 is available.

It is to be understood that the present invention is not limited to the embodiments described above, but encompasses any and all embodiments within the scope of the following claims.

I claim:

1. An add-on safety harness for a vehicle seat having a lap belt comprising:
an elongated main seat anchor strap having a snap-on buckle on one end and a buckle tongue on an opposite end; and
a pair of shoulder harness straps extending from opposite sides of said anchor strap at an acute angle, each said shoulder harness strap having a proximate end attached to said anchor strap and a distal end ending in a loop; and
length adjustment means for adjusting the length of each said shoulder strap;
whereby one end of a conventional lap belt is threaded through said loops of the shoulder harness straps to secure a passenger and the adjustment means being used to adjust the length of said shoulder harness straps.

2. The add-on safety harness according to claim 1, wherein said length adjustment means comprises an adjuster disposed medially on each shoulder strap.

3. The add-on safety harness according to claim 2, further including a strip of soft material having hook and loop fastening material attached to each said adjuster for surrounding each said adjuster device.

4. The add-on safety harness according to claim 1, further including a pair of leg harness straps extending from opposite sides of said anchor strap at an angle, each said leg harness strap having a proximate end attached to said anchor strap and a distal end ending in a loop, and said loops of said leg straps positioned so as to have said loops of said shoulder harness straps disposed therebetween.

5. The add-on safety harness according to claim 1, further including a pair of leg harness straps extending from opposite sides of said anchor strap at an angle, each said leg harness strap having a proximate end attached to said anchor strap and a distal end ending in a loop, and said loops of said leg straps positioned so as to be disposed between said loops of said shoulder harness straps.

6. The add-on safety harness according to claim 1, further including an additional strap member having a first end, a second end, a first mating fastener part coupled to said first end, a second mating fastener part coupled to said second end, and at least one adjuster for adjusting the length of said additional strap;
wherein said additional strap member is disposed around the pair of harness straps for maintaining the pair of harness straps in a proximal position about the chest of the passenger of a vehicle.

7. The add-on safety harness according to claim 1, further including an additional rigid member having a first portion, a second portion, a first mating fastener part coupled to said first portion, a second mating fastener part coupled to said second portion;
wherein said additional rigid member is disposed around the pair of harness straps for maintaining the pair of harness straps in a proximal position about the chest of the passenger of a vehicle.

8. An add-on safety harness for vehicles having at least a lap belt and an anchor point, comprising:
a seat anchor strap having a first end and a second end, a clip-on fastener coupled to said first end;
a pair of harness straps extending from said second end, and extending from opposite sides of said anchor strap at an angle, each said harness strap having a length, a proximate end fixedly attached to said anchor strap and a distal end ending in a loop, whereby forming an inverted Y-shape; and
an adjustment device, disposed on each harness strap, designed and configured to adjust the length of each said harness strap;
wherein said clip-on fastener is releasibly attached to an anchor point of the vehicle; one end of a lap belt of the vehicle is threaded through said loops of said harness straps, whereby a passenger is secured into the vehicle seat, and said adjustment device is used to adjust the tension length of said harness straps.

9. The add-on safety harness according to claim 8, further including a strip of soft material having hook and loop fastening material attached to each said harness strap, in proximity to each adjustment device, said strip of soft material releasibly surrounding each said adjuster device.

10. The add-on safety harness according to claim 8, further including an additional strap member having a first end, a second end, a first mating fastener part coupled to said first end, a second mating fastener part coupled to said second end, and at least one adjuster for adjusting the length of said additional strap;
wherein said additional strap member is disposed around the pair of harness straps for maintaining the pair of harness straps in a proximal position about the chest of the passenger of a vehicle.

11. The add-on safety harness according to claim 8, further including an additional rigid member having a first portion, a second portion, a first mating fastener part coupled to said first portion, a second mating fastener part coupled to said second portion;
wherein said additional rigid member is disposed around the pair of harness straps for maintaining the pair of harness straps in a proximal position about the chest of the passenger of a vehicle.

12. An add-on safety harness kit for vehicle seats having at least a lap belt comprising:
an anchor strap having a first end and a second end, a clip-on fastener coupled to said first end;
a pair of harness straps extending from said second end, and extending from opposite sides of said anchor strap at an angle, each said harness strap having a length, a proximate end fixedly attached to said anchor strap and a distal end ending in a loop, whereby forming an inverted Y-shape;
an adjustment device, disposed on each harness strap, designed and configured to adjust the length of each said harness strap; and
hardware for adapting a portion of a vehicle to define an anchor point, said hardware including at least a bolt, a first washer, an angled plate having an eyelet and a bolt hole, a second washer, and a nut, said angled plate being mounted to the vehicle using said bolt through said bolt hole, said first washer, said second washer, and said nut;
wherein said clip-on fastener is releasibly attached to said eyelet of said angled plate; one end of a lap belt of the vehicle is threaded through said loops of said harness straps, whereby a passenger is secured into the vehicle seat, and said adjustment device is used to adjust the tension length of said harness straps.

13. The add-on safety harness kit according to claim 12, further including a strip of soft material having hook and loop fastening material attached to each said harness strap, in proximity to each adjustment device, said strip of soft material releasibly surrounding each said adjuster device.

14. The add-on safety harness kit according to claim 12, further including an additional strap member having a first end, a second end, a first mating fastener part coupled to said first end, a second mating fastener part coupled to said second end, and at least one adjuster for adjusting the length of said additional strap;
wherein said additional strap is disposed around the pair of harness straps for maintaining the pair of harness straps in a proximal position about the chest of the passenger of a vehicle.

15. The add-on safety harness according to claim 12, further including an additional rigid member having a first portion, a second portion, a first mating fastener part coupled to said first portion, a second mating fastener part coupled to said second portion;
wherein said additional rigid member is disposed around the pair of harness straps for maintaining the pair of harness straps in a proximal position about the chest of the passenger of a vehicle.

16. The add-on safety harness kit according to claim 12, wherein said clip-on fastener is fixedly attached to said first end of said anchor strap.

17. The add-on safety harness kit according to claim 12, wherein said clip-on fastener is slidably attached to said first end of said anchor strap, wherein the length of the anchor strap is adjustable.

18. The add-on safety harness kit according to claim 12, wherein said hardware is mounted to a sure frame component of the vehicle seat.

19. The add-on safety harness kit according to claim 12, wherein said hardware is mounted to a sure frame component of the vehicle floor, beneath the vehicle seat.

20. The add-on safety harness kit according to claim 12, wherein said hardware is mounted to a sure frame component of the vehicle body behind the vehicle seat.
